(19) United States
(12) Patent Application Publication
(10) Pub. No.: US 2011/0089310 A1
(43) Pub. Date: Apr. 21, 2011

(54) MAGNETIC SUPPORT

(76) Inventor: Nicholas Heintz, Eloy, AZ (US)

(21) Appl. No.: 12/906,085

(22) Filed: Oct. 16, 2010

Related U.S. Application Data
(60) Provisional application No. 61/252,281, filed on Oct. 16, 2009.

(51) Int. Cl. F16M 11/26

(52) U.S. Cl. 248/677; 248/157

(57) ABSTRACT

A magnetic telescoping support of fixable length having a magnet at a top end for affixing the telescoping support to a metal object to be supported. The telescoping support is fixable in length by a gross discrete means and a fine continuous means. In operation, the magnet is held in an enclosure that is attached to the top of the telescoping support. By using an annular magnet, a hole is provided for a bolt that is received in a captive nut offset within the top-most telescoping tube and may be used to assist in fixing the magnet enclosure to the top-most telescoping tube. The bolt and captive nut may also be used to assist in attaching the magnetic support to a plate by means of a hole in such plate. The foot of the magnetic support may be flexibly attached.

### RELATED APPLICATIONS

This application claims the benefit of U.S. Provisional Patent Application 61/252,281, filed Oct. 16, 2009, by the same inventor.

### FIELD OF THE INVENTION

This invention relates to a portable and manually installable support for objects that exert compressive and tensile loads on supports. In particular, this invention relates to supports for cantilevered stairs for recreational vehicles (RVs), wherein the support has an annular magnet at the stair-engaging end.

### BACKGROUND

RVs commonly have deployable stairs that slide out from under a side of an RV chassis proximate the door and unfold into a cantilevered configuration when the RV is parked. When the stairs are in use, the weight on the cantilevered stair can exert a roll torque on the RV in a first direction, lowering the stairs toward the ground and giving the user a feeling of unsteadiness. When the stairs are not in use, motion of users (or placement or movement of cargo) within the parked RV can create a roll torque in an opposite (second) direction, raising the stairs away from the ground.

Therefore, a need exists for a support to provide steadiness for users of the stairs.

### OBJECTS AND FEATURES OF THE INVENTION

A primary object and feature of the present invention is to overcome the above-mentioned problems and fulfill the above-mentioned needs.

Another object and feature of the present invention is to provide a support that will support the stairs directly when deployed. Another object and feature of the present invention is to provide a support that is portable, stowable, and easily installed. Another object and feature of the present invention is to provide a support with a magnet for engaging the underside of RV stairs. Another object and feature of the present invention is to provide a support with an annular magnet that may optionally be mechanically fastened through the center of the annulus to the stairs for long-term deployments of the stairs. Another object and feature of the present invention is to provide a support that does not disengage when the stairs move upward.

It is an additional primary object and feature of the present invention to provide a magnetic support that is efficient, inexpensive, easy to clean, and handy. Other objects and features of this invention will become apparent with reference to the following descriptions.

### SUMMARY OF THE INVENTION

In accordance with a preferred embodiment hereof, this invention provides an extendable support for engaging metal RV stairs that includes a telescoping support, an annular magnet fixed to a top end of the telescoping support, an extendable foot coupled to a bottom end of the support, and holes and a pin for fixing the telescoping support in one of a plurality of fixed positions. The annular magnet is preferably encased to reduce damage. The telescoping support has a nut fixed to the support within the support, below the magnet and the magnet enclosure, with the threaded bore of the nut aligned to the annular opening in the magnet case and magnet to enable coupling of the support to the stairs with a bolt or screw having threads complimentary to the threads of the nut. The extendable foot preferably extends on a screw through a second nut fixed to or within the support proximate the lower end of the support. The foot may have a pivot to permit adaptation to uneven ground.

A magnetic support, including: an outer cylindrical tube having first and second outer cylindrical tube ends; an inner cylindrical tube slidingly receivable within the second outer cylindrical tube end; a magnet enclosure that is one of attached to and attachable to the first end of the outer cylindrical tube; and a magnet supported in the magnet enclosure. The magnetic support, where the inner cylindrical tube has first and second inner cylindrical tube ends, the magnetic support including: the first inner cylindrical tube end slidingly receivable into the second end of the outer cylindrical tube; a threaded rod having first and second ends, where the first threaded rod end is rotatably received in the second inner cylindrical tube end and where the second threaded rod end extends from the second inner cylindrical tube end; and a foot attached to the second threaded rod end. The magnetic support further including: a first threaded nut, for receiving the first end of the threaded rod, fixed proximal to the second inner cylindrical tube end that is fixed either interior to the second inner cylindrical tube or abutting the second inner cylindrical tube end; and a foot nut fixed to the foot for receiving and supporting the second threaded rod end. The magnetic support, where the magnet includes an annular magnet, the attachment of the magnetic enclosure including: a second threaded nut fixed within the outer cylindrical tube and spaced apart from the outer cylindrical tube first end; a central opening in the magnet enclosure, where the central opening is coaxially alignable with the second threaded nut; and a bolt for attaching the magnet support through the annular magnet, the central opening, and the second threaded nut. The magnetic support, where the foot is flexibly attached to the second threaded rod end. The magnetic support, where the magnet includes an annular magnet. The magnetic support, including means for adjustably fixing a particular sliding relationship between the outer cylindrical tube and the inner cylindrical tube, further including: at least one first pair of transverse holes in the outer cylindrical tube; at least one second pair of transverse holes in the inner cylindrical tube, where the at least one first pair of transverse holes is slidingly alignable to the at least one second pair of transverse holes for receiving a pin to secure the inner cylindrical tube from sliding within the outer cylindrical tube. The magnetic support, where the magnet enclosure completely encloses the magnet. The magnetic support, where the magnet enclosure includes a magnetically permeable material.

A magnetic support, including: an outer cylindrical tube having first and second outer cylindrical tube ends; an inner cylindrical tube, having first and second inner cylindrical tube ends, the first inner cylindrical tube end is slidingly receivable within the second outer cylindrical tube end; a first threaded nut, fixed proximal to the second inner cylindrical tube end that is fixed either interior to the second inner cylindrical tube or abutting the second inner cylindrical tube end; a threaded rod having first and second rod ends, where the first rod end is rotatably engaged with the first threaded nut; a foot coupled to the second rod end; a magnet enclosure that is one of attached to and attachable to the first end of the outer cylindrical tube; an attachment including: a second threaded nut fixed within the outer cylindrical tube and proximal to and spaced apart from the outer cylindrical tube first end and a bolt having threads complimentary to the second threaded nut; and a magnet at least partially enclosed in the magnet enclosure. The magnetic support, where the magnet includes an annular magnet. The magnetic support, where the bolt has a length sufficient to engage the second threaded nut through the magnet enclosure and through a portion of a plate to which the magnetic support is to be attached. The magnetic support, further including: at least one first pair of aligned transverse holes in the outer cylindrical tube; at least one second pair of aligned transverse holes in the inner cylindrical tube, where the at least one first pair of transverse holes is slidingly alignable to the at least one second pair of transverse holes for receiving a pin to secure the inner cylindrical tube from sliding within the outer cylindrical tube. The magnetic support in a kit, the kit further including: the pin; and a securer for assisting in securing the magnetic support in a stowed position.

A method of using a magnetic support kit with a deployable cantilever stair, where the magnetic support kit includes a telescoping support that is fixable in extended length my means of at least one of a pin and a rotationally extendable foot, and having a magnet in a magnetic enclosure fixed abutted to a top end of the magnetic support, a top threaded nut fixed within the telescoping support and proximal to, and offset from, a top end of the magnetic support, a pin, and a securer, the method, including the steps of: removing the magnetic support from a stowed position on such deployable cantilever stair; partially deploying such deployable cantilever stair into a first intermediate position; coupling the magnetic support to an underside portion of such deployable cantilever stair; extending the magnetic support to engage an environmental surface with the foot; fully deploying such deployable cantilever stair to a fully deployed position. The method, further including the step of: stowing the magnetic support under such deployable cantilever stair, while such deployable cantilever stair is configured in a stowed position, by attaching the magnetic support using the magnet. The method, further including the step of securing the magnetic support using at least one of the securer and the bolt. The method, where the step of coupling includes magnetic coupling. The method, where the step of coupling further includes physically coupling the magnetic support to such stair using the bolt through an opening in such stair, through the magnet enclosure and magnet, and into the top nut. The method, further including the step of retracting the magnetic support to a minimum fixable length prior to the step of attaching.

### BRIEF DESCRIPTION OF THE DRAWINGS

The above and other objects and advantages of the present invention will become more apparent from the following description taken in conjunction with the following drawings in which:

FIG. 1 is an elevation view illustrating an exemplary magnetic support defining a cross-section A-A′, according to a preferred embodiment of the present invention;

FIG. 2 is a cross-sectional view through cross section A-A′ illustrating the exemplary magnetic support of FIG. 1, according to a preferred embodiment of the present invention;

FIG. 3 is an elevation view illustrating a second exemplary magnetic support defining cross-sections B-B′ and C-C′, according to a preferred embodiment of the present invention;

FIG. 4 is a cross-sectional view through cross section B-B′ illustrating the exemplary magnetic support of FIG. 3, according to a preferred embodiment of the present invention;

FIG. 5 is a bottom plan view illustrating the exemplary magnetic supports of FIGS. 1-4, according to the preferred embodiments of the present invention;

FIG. 6 is a top plan view illustrating the exemplary magnetic supports of FIGS. 1-4, according to the preferred embodiments of the present invention;

FIG. 7 is a cross-sectional view through cross section C-C′ illustrating the exemplary magnetic supports of FIGS. 1-4, according to the preferred embodiments of the present invention;

FIG. 8 is a partial cross-sectional view through section B-B′ illustrating optional mechanical coupling of the magnetic supports of FIGS. 1-4, according to the preferred embodiments of the present invention;

FIG. 9 is a perspective photo-trace view illustrating a third exemplary embodiment of a magnetic support, according to a preferred embodiment of the present invention;

FIG. 10 is a side elevation diagrammatic view illustrating the exemplary magnetic support of FIG. 9, according to a preferred embodiment of the present invention;

FIG. 11 is a side elevation diagrammatic view illustrating the exemplary magnetic support of FIG. 9, according to a preferred embodiment of the present invention;

FIG. 12 is a side elevation diagrammatic view illustrating the exemplary magnetic support of FIG. 9 in a stowed position, according to a preferred embodiment of the present invention;

FIG. 13 is a side elevation diagrammatic view illustrating the exemplary magnetic support of FIG. 9 in an installed position, according to a preferred embodiment of the present invention; and

FIG. 14 is a side elevation diagrammatic view illustrating the exemplary magnetic support of FIG. 9 in a deployed position, according to a preferred embodiment of the present invention.

### DETAILED DESCRIPTION OF THE BEST MODES AND PREFERRED

2 EMBODIMENTS OF THE INVENTION

Like reference numbers on various drawings refer to the same parts so referenced.

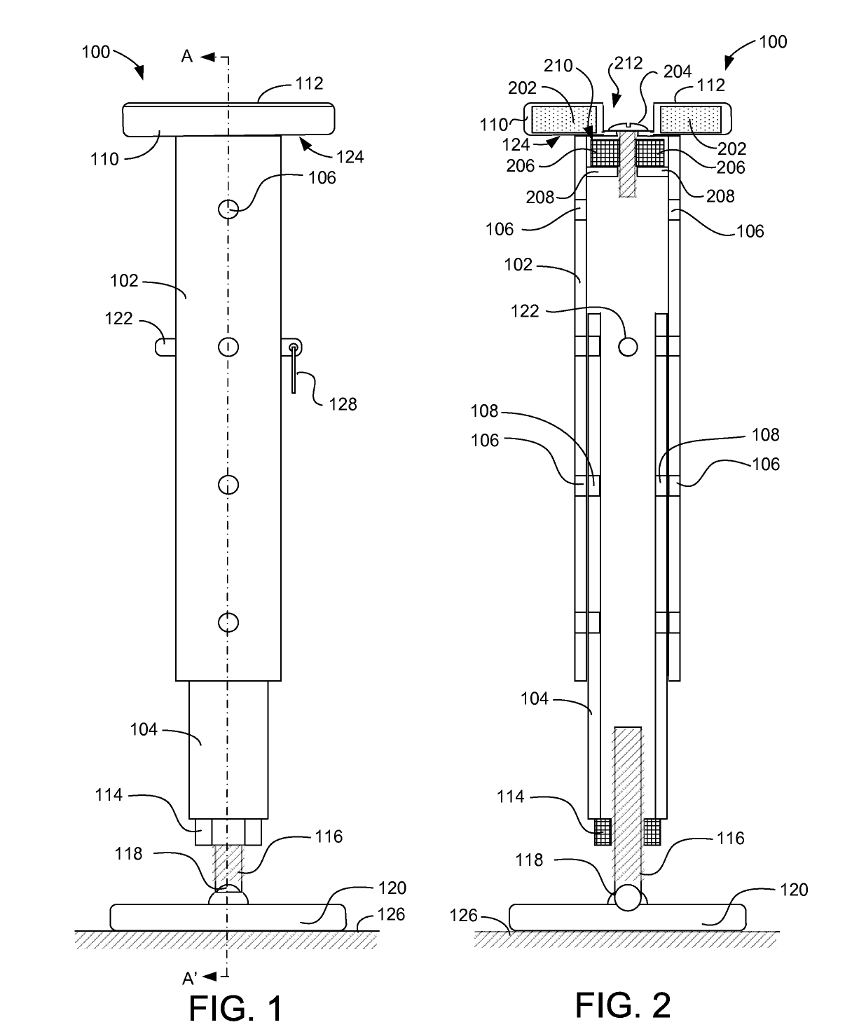

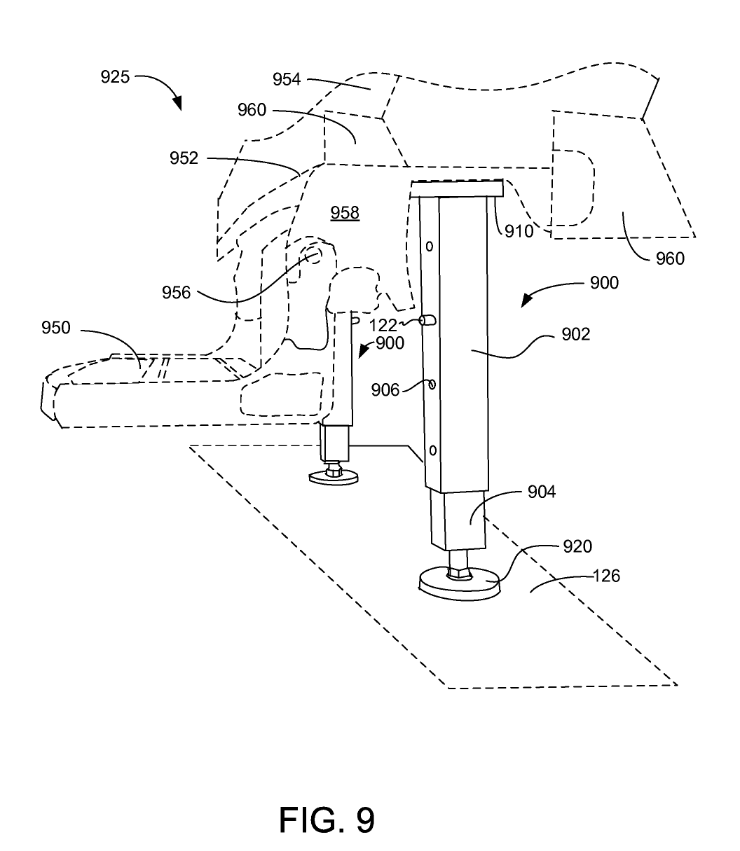

FIG. 1 is an elevation view illustrating an exemplary magnetic support 100 defining a cross-section A-A′, according to a preferred embodiment of the present invention. The elevation view of FIG. 1 is of any of four sides of the magnetic support 100 except for pin 122. Magnetic support 100 operates in a generally vertical orientation, as shown, to support a deployable cantilevered RV stair 925 (See FIG. 9) or similar vertically variable load. Outer cylindrical tube 102 telescopes, or is slidingly received, with inner cylindrical tube 104. Inner and outer cylindrical tubes 104, 102 are preferably made of a strong, lightweight, rigid material such as, without limitation, aluminum, composite, fiberglass, PVC pipe, polymer, or ceramic. In applications where weight is less important, such as long-term installed use applications, steel may be used. Outer cylindrical tube 102 and inner cylindrical tube 104 are preferably made from open-ended cylindrical shells, more preferably open-ended polygonal cylindrical shells, and most preferably open-ended polygonal cylindrical shells with square cross sections, as shown. In various alternative embodiments other cross-sectional shapes, including irregular cylindrical shapes, for outer cylindrical tube 102 and inner cylindrical tube 104 may be preferred. Inner cylindrical tube 102 is slidingly received in outer cylindrical tube 104.

Outer cylindrical tube 102 fixedly supports an enclosure 110 for an annular magnet 202 (see FIG. 2). Enclosure 110 is of a durable, preferably magnetically permeable material, such as, without limitation, polymer or hard rubber. Enclosure 110 may optionally have a cap 112. Enclosure 110 preferably has a lower outer surface 124 extending transversely beyond the outer cylindrical tube 102.

Outer cylindrical tube 102 has a plurality of pairs of aligned opposing holes 106 transverse to and completely through the outer cylindrical tube 102, allowing passage of pin 122 through the outer cylindrical tube 104. Inner cylindrical tube 104 has a complimentary plurality of pairs of aligned opposing holes 108 (See FIG. 2) which align, at discrete positions of the inner cylindrical tube 104 relative to the outer cylindrical tube 102, to at least one pair of aligned opposing holes 106 in outer cylindrical tube 102 to allow the telescoped inner cylindrical tube to be releasably fixed in position. Thus the height of magnetic support 100 can be varied in discrete increments. Aligned opposing holes 106 may be on one pair of opposing sides of magnetic support 100 or on each pair of opposing polygonal sides, as shown. Thus, gross changes in length may be achieved by discrete adjustment.

For variation of height between or beyond discrete increments, an extendable foot 120 is coupled to the bottom of inner cylindrical tube 104. Extendable foot 120 is coupled to threaded rod 116 through pivot 118. Pivot 118 provides some adaptability to variations in the environmental surface 126 below the RV stair 925 (See FIG. 9). Threaded rod 116 is rotatably received in the inner cylindrical tube 104 by screwing into nut 114 to extend or retract foot 120. In an alternate embodiment, nut 114 may be entirely within lower cylindrical tube 104, rather than exterior to inner cylindrical tube 104, as shown.

Pin 122 has a pull ring 128 to improve ease of removing pin 122. Pin 122 is preferably made of the same material as outer cylindrical tube 102 and inner cylindrical tube 104.

FIG. 2 is a cross-sectional view through cross section A-A′ illustrating the exemplary magnetic support 100 of FIG. 1, according to a preferred embodiment of the present invention. The alignment of complimentary holes 106 and 108 may provide options for placement of pin 122 to improve the ease of installation. Annular magnet 202 may be seen within enclosure 110 and below optional cap 112. Optional bolt 204 is received through annular opening 212 in magnet enclosure 110, through inner top nut 106, and through nut support 208. The top surface 210 of inner top nut 206 is recessed, or spaced apart, from the top of outer cylindrical tube 102 upon which lower surface 124 of enclosure 110 is fixed to allow welding in of the inner top nut 206 without making the top surface of outer cylindrical tube 102 uneven. Nut support 208 is optional. In a particular embodiment, nut support 208 may be a few deposits of weld just sufficient to hold the inner top nut 206 for top welding. In a preferred embodiment, the inner top nut 206 is held in place by a welding jig comprising a pole that extends up inside outer cylindrical tube 104 to the level of nut support 208, and holds the inner top nut 206 in place for welding. An additional reason for optional bolt (or screw) 204 will be discussed below.

Inner cylindrical tube 104 is slidingly received in outer cylindrical tube 102.

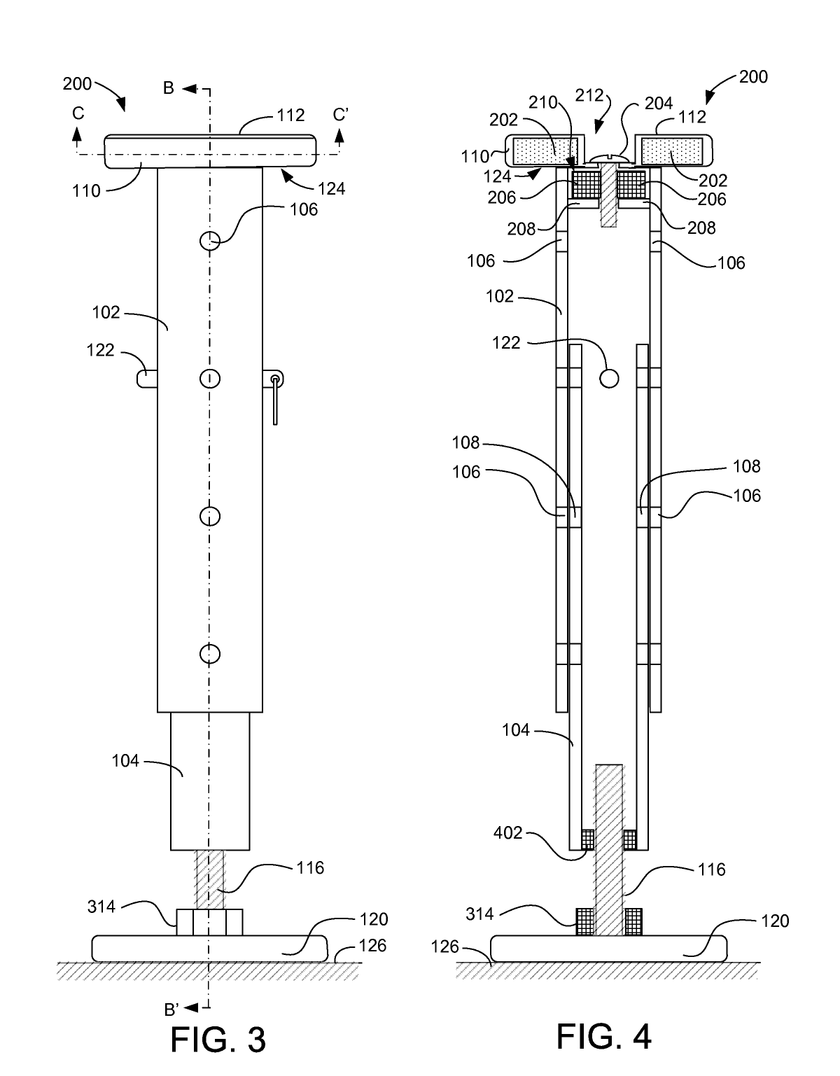

FIG. 3 is an elevation view illustrating a second exemplary magnetic support 200 defining cross-sections B-B′ and C-C′, according to a preferred embodiment of the present invention. Magnetic support 200 is like magnetic support 100 except that foot 120 is rigidly, rather than pivotably, coupled to threaded rod 116. Foot nut 314 is fixed to foot 120 and threaded rod 116.

FIG. 4 is a cross-sectional view through cross section B-B′ illustrating the exemplary magnetic support 200 of FIG. 3, according to a preferred embodiment of the present invention. Inner bottom nut 402 is fixed within inner cylindrical tube 104 and receives threaded rod 116 to adjust the extension of foot 120 from the bottom of inner cylindrical tube 104.

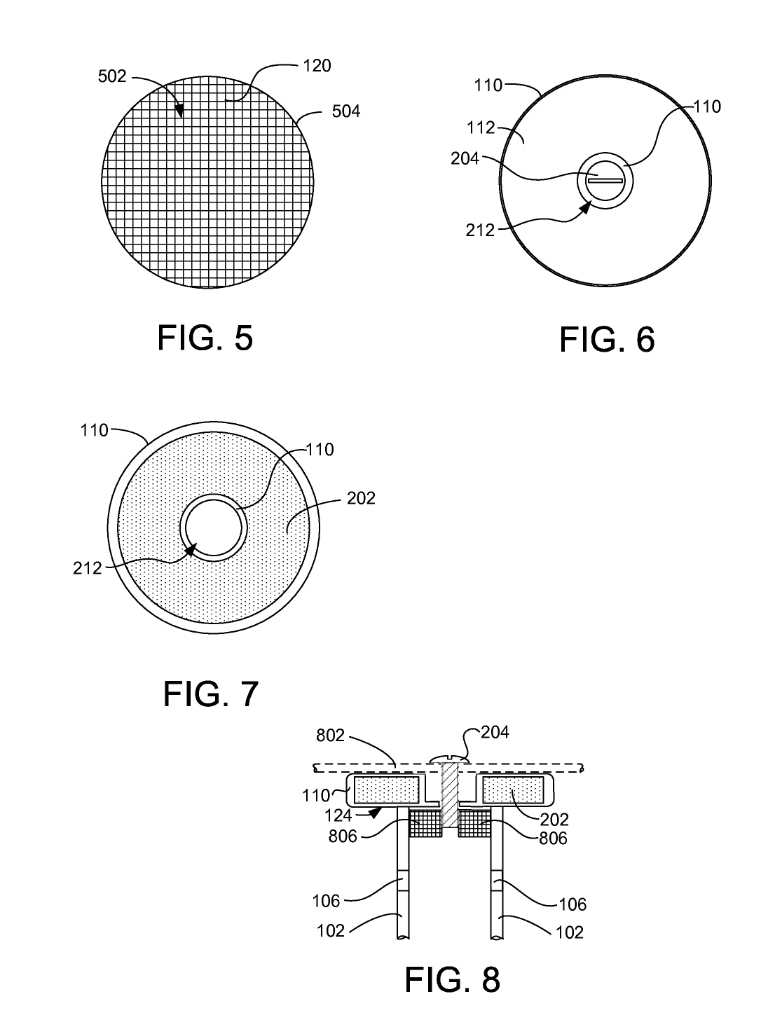

FIG. 5 is a bottom plan view illustrating the exemplary magnetic supports 100 and 200 of FIGS. 1-4, according to the preferred embodiments of the present invention. The perimeter 504 of foot 120 is preferably circular, as shown. In various other embodiments, various other shapes may be used. Bottom surface 502 of foot 120 is preferably textured to improve frictional engagement with the environmental surface 126.

FIG. 6 is a top plan view illustrating the exemplary magnetic supports 100 and 200 of FIGS. 1-4, according to the preferred embodiments of the present invention. The top of optional bolt (or screw) 204 may be seen within annular opening 212. Optional bolt (or screw) 204 may be use to secure enclosure 110 to outer cylindrical tube 102, but enclosure 110 is preferably fixed to outer cylindrical tube 102 by other means such as, without limitation, welding or gluing.

FIG. 7 is a cross-sectional view through cross section C-C′, as defined in FIG. 3, illustrating the exemplary magnetic supports 100 and 200 of FIGS. 1-4, according to the preferred embodiments of the present invention. Annular magnet 202 is preferably strong enough to support the weight of the entire magnetic support 100 or 200. For this reason, lightweight materials are most preferred for making magnet supports 100 and 200.

FIG. 8 is a partial cross-sectional view through section B-B′, as defined in FIG. 3, illustrating optional mechanical coupling of the magnetic supports 100 and 200 of FIGS. 1-4, according to the preferred embodiments of the present invention. Stair panel 802 may be fastened to magnetic support 100 or 200 using optional bolt (or screw) 204. This method is for use in long-term installations. Inner top nut 806 was welded in using a welding jig, as previously described.

FIG. 9 is a perspective photo-trace view with a cut-away illustrating a third exemplary embodiment of a magnetic support 900, according to a preferred embodiment of the present invention. A deployable cantilevered stair 925 is shown extended from an RV 954 and coupled to RV 954 by supports 960. Top stair 952 has side panels 958 which provide pivots 956 to rotate bottom stair 950 into the position shown. Magnetic support 900 is similar to magnetic supports 100 and 200, but has aligned opposing holes 906 on only one pair of opposing sides of inner cylindrical tube 904 and outer cylindrical tube 902. Enclosure 910 magnetically engages the underside of the top stair 952 and foot 920 engages environmental surface 126. A pair of magnetic supports 900 is shown in use. Depending on details of the particular application, one or more magnetic supports 100, 200, or 900 may be used.

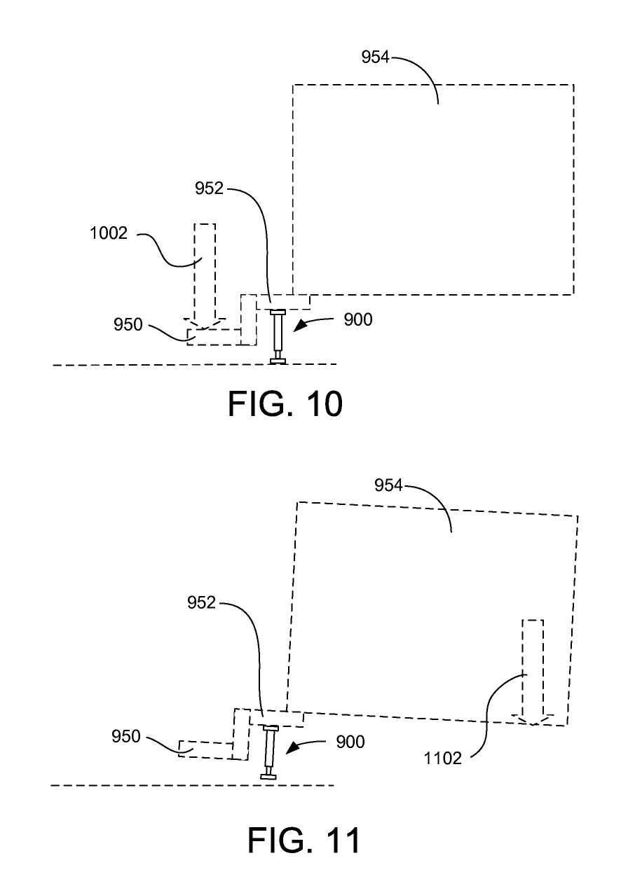

FIG. 10 is a side elevation diagrammatic view illustrating the exemplary magnetic support 900 of FIG. 9, according to a preferred embodiment of the present invention. When a downward force 1002 is exerted on bottom stair 950 or top stair 952, magnetic support 900 experiences a compressive load, which assists in maintaining magnetic support 900 in position.

FIG. 11 is a side elevation diagrammatic view illustrating the exemplary magnetic support 900 of FIG. 9, according to a preferred embodiment of the present invention. When a downward force 1102 is exerted on the RV 954 distal from the stairs 950 and 952, RV 954 may roll on its suspension to create an upward movement of the stairs 950 and 952. Novel magnetic support 900 (or magnetic support 100 or 200) remains attached to the underside of top stair 952, as shown, where a conventional free-standing support would detach and may fall over.

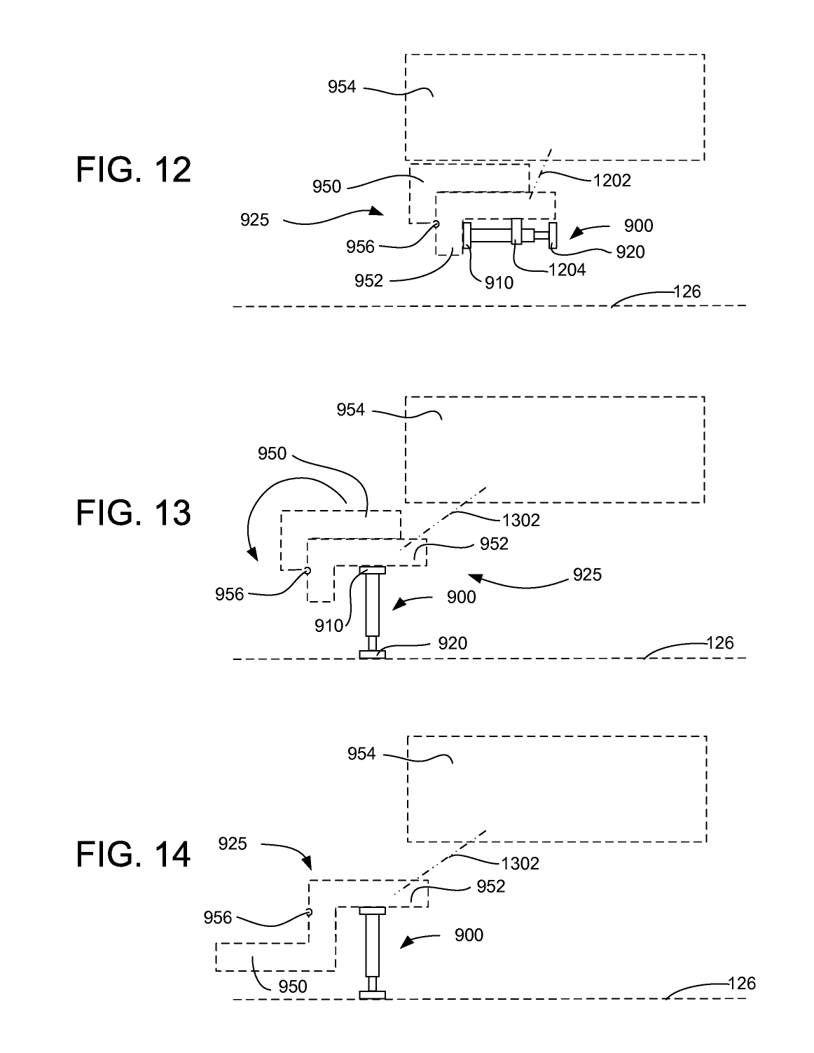

FIG. 12 is a side elevation diagrammatic view illustrating the exemplary magnetic support 900 of FIG. 9 in a stowed position under RV 954, according to a preferred embodiment of the present invention. RV 954 is mechanically linked to deployable cantilevered RV stair assembly 925 by linkage 1202, the details of which are well known in the art and need not be repeated here. In addition to the magnetic attachment of the enclosed 110 annular magnet 202, mechanical securers 1204 may be used to assist in stowing magnetic support 900 (or 100 or 200) under, on, or in the stowed stair assembly 925. Those of skill in the art, enlightened by the present disclosure, will appreciate the variety of styles of deployable cantilevered RV stair assemblies 925 and the various deployment methods used. Magnetic support 900 is adaptable to stowage in a wide variety of such deployable cantilevered RV stair assemblies 925. While shown extended to an operational length, the magnetic support 900 may be refracted to its minimum length to assist with fitting into small spaces or lengthened to engage supportive surfaces of the stowed stair assembly 925.

FIG. 13 is a side elevation diagrammatic view illustrating the exemplary magnetic support 900 of FIG. 9 in an installed position, according to a preferred embodiment of the present invention. The deployable cantilevers stair assembly 925 has been partially deployed from under RV 954 using a reconfiguration of linkage 1202 into extended linkage 1302, the details of which are well known in the art and need not be repeated here. The magnetic support 900 has been magnetically attached to the underside of stair 952 and adjusted in extension to engage environmental surface 126. Magnetic support 900 is adjusted in extension by telescoping the internal cylindrical tube 104 within outer cylindrical tube 102, fixing the sliding relationship with pin 122, and rotating threaded rod 116 to extend or retract foot 120 to achieve the desired length for magnetic support 900.

FIG. 14 is a side elevation diagrammatic view illustrating the exemplary magnetic support 900 of FIG. 9 in an installed position, according to a preferred embodiment of the present invention. Deployable cantilevered stair 950 has been rotated out (see the curved arrow in FIG. 13) via pivot 956 into the operational configuration for stair assembly 925.

Magnetic supports 900 of various sizes may be made and put to additional uses. For example, a magnetic support 900 sized to fit under stair 950 in the deployed configuration may be used instead of or in addition to magnetic supports 900 under stair 952. Additionally, a magnetic support 900 for various structural members that are made of materials that may be magnetically engaged may be used in a variety of applications, as will be understood by those of skill in the art who are enlightened by the present disclosure.

The embodiments presented herein are merely exemplary. The invention is limited only as stated in the following claims as interpreted in light of the specification. For example, in a particular embodiment, more than two telescoping tubes may be used, various means of fixing the sliding relationships of the tubes may be employed (such as those known in the art of tripod making), and magnets of various types, shapes and sizes may be employed. Likewise, applications of the invention beyond those exemplified here, and that are obvious to those of skill in the art who are illuminated by the present disclosure, are within the scope of the invention.

I claim:

1. A magnetic support, comprising:
a. an outer cylindrical tube having first and second outer cylindrical tube ends;
b. an inner cylindrical tube slidingly receivable within said second outer cylindrical tube end;
c. a magnet enclosure that is one of attached to and attachable to said first end of said outer cylindrical tube; and
d. a magnet supported in said magnet enclosure.

2. The magnetic support of claim 1, wherein said inner cylindrical tube has first and second inner cylindrical tube ends, the magnetic support comprising:
a. said first inner cylindrical tube end slidingly receivable into said second end of said outer cylindrical tube;
b. a threaded rod having first and second ends, wherein said first threaded rod end is rotatably received in said second inner cylindrical tube end and wherein said second threaded rod end extends from said second inner cylindrical tube end; and
c. a foot attached to said second threaded rod end.

3. The magnetic support of claim 2, further comprising:
a. a first threaded nut, for receiving said first end of said threaded rod, fixed proximal to said second inner cylindrical tube end that is fixed one of:
i. interior to said second inner cylindrical tube; and
ii. abutting said second inner cylindrical tube end; and
b. a foot nut fixed to said foot for receiving and supporting said second threaded rod end.

4. The magnetic support of claim 2, wherein said magnet comprises an annular magnet, the attachment of said magnetic enclosure comprising:
a. a second threaded nut fixed within said outer cylindrical tube and spaced apart from said outer cylindrical tube first end;
b. a central opening in said magnet enclosure, wherein said central opening is coaxially alignable with said second threaded nut; and
c. a bolt for attaching said magnet support through said annular magnet, said central opening, and said second threaded nut.

5. The magnetic support of claim 2, wherein said foot is flexibly attached to said second threaded rod end.

6. The magnetic support of claim 1, wherein said magnet comprises an annular magnet.

7. The magnetic support of claim 1, comprising means for adjustably fixing a particular sliding relationship between said outer cylindrical tube and said inner cylindrical tube, further comprising:
a. at least one first pair of transverse holes in said outer cylindrical tube;
b. at least one second pair of transverse holes in said inner cylindrical tube, wherein said at least one first pair of transverse holes is slidingly alignable to said at least one second pair of transverse holes for receiving a pin to secure said inner cylindrical tube from sliding within said outer cylindrical tube.

8. The magnetic support of claim 1, wherein said magnet enclosure completely encloses said magnet.

9. The magnetic support of claim 1, wherein said magnet enclosure comprises a magnetically permeable material.

10. A magnetic support, comprising:
a. an outer cylindrical tube having first and second outer cylindrical tube ends;
b. an inner cylindrical tube, having first and second inner cylindrical tube ends, said first inner cylindrical tube end is slidingly receivable within said second outer cylindrical tube end;
c. a first threaded nut, fixed proximal to said second inner cylindrical tube end that is fixed one of:
i. interior to said second inner cylindrical tube; and
ii. abutting said second inner cylindrical tube end;
d. a threaded rod having first and second rod ends, wherein said first rod end is rotatably engaged with said first threaded nut;
e. a foot coupled to said second rod end;
f. a magnet enclosure that is one of attached to and attachable to said first end of said outer cylindrical tube;
g. an attachment comprising:
i. a second threaded nut fixed within said outer cylindrical tube and proximal to and spaced apart from said outer cylindrical tube first end; and
ii. a bolt having threads complimentary to said second threaded nut; and
h. a magnet at least partially enclosed in said magnet enclosure.

11. The magnetic support of claim 10, wherein said magnet comprises an annular magnet.

12. The magnetic support of claim 11, wherein said bolt has a length sufficient to engage said second threaded nut through said magnet enclosure and through a portion of a plate to which said magnetic support is to be attached.

13. The magnetic support of claim 12, further comprising:
a. at least one first pair of aligned transverse holes in said outer cylindrical tube;
b. at least one second pair of aligned transverse holes in said inner cylindrical tube, wherein said at least one first pair of transverse holes is slidingly alignable to said at least one second pair of transverse holes for receiving a pin to secure said inner cylindrical tube from sliding within said outer cylindrical tube.

14. The magnetic support of claim 12 in a kit, said kit further comprising:
a. said pin; and
b. a securer for assisting in securing said magnetic support in a stowed position.

15. A method of using a magnetic support kit with a deployable cantilever stair, wherein said magnetic support kit comprises a telescoping support that is fixable in extended length my means of at least one of a pin and a rotationally extendable foot, and having a magnet in a magnetic enclosure fixed abutted to a top end of said magnetic support, a top threaded nut fixed within said telescoping support and proximal to, and offset from, a top end of said magnetic support, a pin, and a securer, the method comprising the steps of:
a. removing said magnetic support from a stowed position on such deployable cantilever stair;
b. partially deploying such deployable cantilever stair into a first intermediate position;
c. coupling said magnetic support to an underside portion of such deployable cantilever stair;
d. extending said magnetic support to engage an environmental surface with said foot;
e. fully deploying such deployable cantilever stair to a fully deployed position.

16. The method of claim 15, further comprising the step of: stowing said magnetic support under such deployable cantilever stair, while such deployable cantilever stair is configured in a stowed position, by attaching said magnetic support using said magnet.

17. The method of claim 16, further comprising the step of securing said magnetic support using at least one of the securer and the bolt.

18. The method of claim 15, wherein the step of coupling comprises magnetic coupling.

19. The method of claim 18, wherein said step of coupling further comprises physically coupling said magnetic support to such stair using said bolt through an opening in such stair, through said magnet enclosure and magnet, and into said top nut.

20. The method of claim 15, further comprising the step of retracting said magnetic support to a minimum fixable length prior to said step of attaching.
